(19) United States
(12) Patent Application Publication
(10) Pub. No.: US 2022/0223014 A1
(43) Pub. Date: Jul. 14, 2022

(54) Device and Method for Providing Haptic Feedback to a User

(71) Applicant: Vestel Elektronik Sanayi ve Ticaret A.S., Manisa (TR)

(72) Inventor: Nevzat YALIN, Manisa (TR)

(21) Appl. No.: 17/608,065

(22) PCT Filed: May 3, 2019
(86) PCT No.: PCT/EP2019/061395

§ 371 Date: Nov. 1, 2021

(51) Int. Cl. G08B 6/00; G06F 3/01

(52) U.S. Cl. CPC G08B 6/00; G06F 3/016

(57) ABSTRACT

Devices and methods for providing haptic feedback to a user. A first solenoid is constructed and arranged to move a first magnetic object to a first end of the first solenoid where the first magnetic object can be felt by the user when a current is supplied through the first solenoid. A second solenoid is constructed and arranged to move a second magnetic object to a first end of the second solenoid where the second magnetic object can be felt by the user when a current is supplied through the second solenoid. The first and second magnetic objects have different shapes so as to provide different haptic feedback sensations to the user.

### TECHNICAL FIELD

The present disclosure relates to a device and a method for providing haptic feedback to a user.

### BACKGROUND

Haptic technology (also called kinaesthetic technology) encompasses hardware and methods to enable a device to provide tactile stimulation to a user. Known devices for generating haptic feedback do so by generating vibrations which can be felt by the user. For example, a vibration actuator such as a linear resonant actuator (LRA), eccentric rotating mass (ERM), or piezo actuator may be provided to generate vibrations in response to a control signal. Such known devices suffer from one or more limitations.

### SUMMARY

According to a first aspect disclosed herein, there is provided a device for providing haptic feedback to a user, the device comprising: a first magnetic object; a first solenoid constructed and arranged to move the first magnetic object to a first end of the first solenoid where the first magnetic object can be felt by the user when a current is supplied through the first solenoid; a second magnetic object; and a second solenoid constructed and arranged to move the second magnetic object to a first end of the second solenoid where the second magnetic object can be felt by the user when a current is supplied through the second solenoid; wherein the first and second magnetic objects have different shapes so as to provide different haptic feedback sensations to the user.

In an example, at least one of the solenoids comprises a sheet which covers the first end of the solenoid to contain the respective magnetic object within the solenoid as the object is moved to the first end of the solenoid.

The sheet is such that the user can feel the magnetic object through the sheet when the magnetic object is moved to the first end of the solenoid and strikes the sheet.

In an example, each of the solenoids comprises a sheet which covers the first end of the solenoid to contain the respective magnetic object within the solenoid.

There may be separate sheets for each solenoid, or a particular sheet may cover plural or even all solenoids.

In an example, the or each sheet is electrically conductive and is constructed and arranged to contact one or more of the solenoids when pressed by the user to complete a circuit through the one or more of the solenoids, thereby allowing a current to be supplied through said one or more of the solenoids.

In an example, the device comprises: a third magnetic object; and a third solenoid constructed and arranged to move the third magnetic object to a first end of the third solenoid where the third magnetic object can be felt by the user when a current is supplied through the third solenoid; wherein the third magnetic object has a different shape from each of the first and second magnetic objects and thereby provides a different haptic feedback sensation to the user.

In an example, the shape of at least one of the magnetic objects is spherical.

In an example, the shape of at least one of the magnetic objects is a convex polyhedron.

In an example, the shape of at least one of the magnetic objects is a concave polyhedron.

In an example, the shape of at least one of the magnetic objects is a stellated polyhedron.

In an example, the shape of at least one of the magnetic objects is a stellated dodecahedron.

In an example, one or more of the solenoids is constructed and arranged to move a plurality of magnetic objects of the same shape to the first end of the solenoid.

There is also provided an apparatus comprising a controller for controlling the apparatus, and a device as described above, the solenoids of the device being in communication with the controller, and the controller being arranged to issue control commands to control the apparatus in accordance with the solenoid or solenoids through which a current is being supplied in use.

According to a second aspect disclosed herein, there is provided a method of providing haptic feedback to a user, the method comprising: selectively supplying a current to one or more of a first solenoid and a second solenoid; wherein supplying the current to the first solenoid causes the first solenoid to move a first magnetic object to a first end of the first solenoid where the first magnetic object can be felt by the user, the first object having a first shape for providing a first haptic feedback sensation to the user; wherein supplying the current to the second solenoid causes the second solenoid to move a second magnetic object to a first end of the second solenoid where the second magnetic object can be felt by the user, the second object having a second shape different from the first shape for providing a second haptic feedback sensation to the user different from the first haptic sensation.

In an example, the method comprises selectively supplying a current to one or more of the solenoids by selectively pressing an electrically conductive sheet to contact the one or more of the solenoids to complete a circuit through the one or more of the solenoids, thereby allowing a current to be supplied through the one or more of the solenoids.

In an example, the shape of at least one of the magnetic objects is spherical.

In an example, the shape of at least one of the magnetic objects is a convex polyhedron.

In an example, the shape of at least one of the magnetic objects is a concave polyhedron.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a device for providing haptic feedback to a user;

FIG. 2 shows schematically a portion of another example device comprising three solenoids; and

FIG. 3 shows schematically a portion of another example device comprising different numbers of magnetic objects.

### DETAILED DESCRIPTION

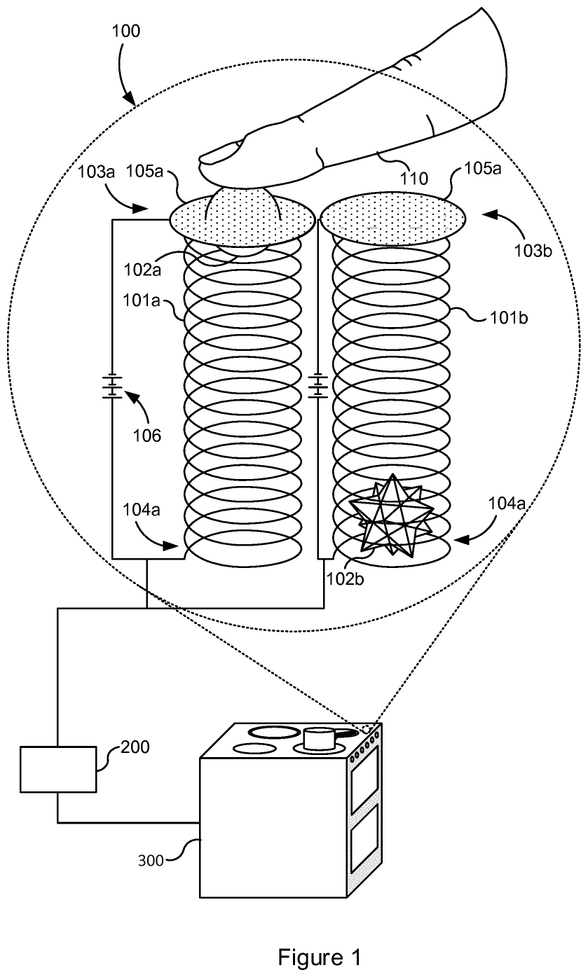

FIG. 1 shows schematically an example of a device 100 for providing haptic feedback to a user. In use, the device 100 may be connected to a controller 200 for controlling an apparatus 300, as described in more detail below.

The device 100 comprises a first solenoid 101a containing a first magnetic object 102a. The first solenoid 101a has a first end 103a and a second end 104a. The first magnetic object 102a is free to move within the first solenoid 101a. Similarly, the device 100 comprises a second solenoid 101b containing a second magnetic object 102b. The second solenoid 101b has a first end 103b and a second end 104a. The second magnetic object 102b is free to move within the second solenoid 101b.

Each solenoid 101 is constructed and arranged to move the respective magnetic object 102 when the solenoid 101 is activated by supplying a current through the solenoid 101. In the example shown in FIG. 1, the first solenoid 101a is activated and the second solenoid 101b is not activated. Hence, the first object 102a is located at the first end 103a of the first solenoid 101a. On the other hand, the second magnetic object 102b is located at the second end 104a of the second solenoid 101b.

The controller 200 is configured to determine which one or more of the solenoids 101 has been activated and to provide a corresponding control command to the apparatus 300. As an illustrative example, the apparatus 300 may be an oven. The controller 300 may for example send a “temperature decrease” command to the apparatus 300 in response to activation of the first solenoid 101a, and a “temperature increase” command to the apparatus 300 is response to activation of the second solenoid 101b.

Activation of a solenoid 101 causes the respective magnetic object 102 to accelerate towards the first end 103 of the solenoid 101 where it can be felt by the user. The magnetic objects 102 moved and contained by each solenoid 101 are arranged to provide different haptic sensations to the user. For example, the magnetic objects 102 may be differently shaped. Hence, the user is able to determine which solenoid 101 has been activated and therefore which control command has been sent to the apparatus 300 using only his or her sense of touch. This is particularly advantageous for blind or partially sighted users.

The working principle is described below and is the same for both the first solenoid 101a and the second solenoid 101b, and any further solenoids as described later.

The magnetic objects 102 are, for example, ferromagnetic or formed at least partially of a ferromagnetic material. When a current is supplied through the solenoid 101, the solenoid 101 generates a magnetic field through its interior, causing the magnetic object 102 to experience a force. As the magnetic object 102 is free to move within the solenoid 101, the magnetic object 102 can move when acted upon by the force.

In the examples shown in the drawings, the solenoids 102 are arranged vertically (that is, with their longitudinal axes arranged vertically). The first ends 103 of the solenoids 101 are uppermost. Hence, when no current is supplied through a solenoid 101 (and therefore no electromagnetic force is applied to the magnetic object 101), the magnetic object 101 will rest at the second end 104 (the bottom) of the solenoid 101 due to gravity. By applying the appropriately-directed current, a force can be applied to the magnetic object 102 which overcomes the force of gravity and thereby moves the magnetic object 102 to the first end 103 (the top) of the solenoid 101.

The first and second magnetic objects 102a, 102b are not shown to scale in the figures and may in practice be somewhat smaller than suggested by the Figures. There may be plural first magnetic objects 102a contained within the first solenoid 101a and/or plural second magnetic objects 102b contained within the second solenoid 101b.

The first solenoid 101a and second solenoid 101b are arranged parallel to each other. FIG. 1 shows a finger 110 of a user located proximal to the first end 103b of the first solenoid 101a. The second ends 104 of the solenoids 101 may be obstructed to prevent the magnetic objects 102 from leaving the solenoids 101 via the second ends 104. For example, each second end 104 may be blocked by a bung or cap or other stopper (not shown).

Each first end 103 may also be obstructed to prevent the magnetic objects 102 from leaving the solenoids 101. However, any obstruction provided at the first ends 103 needs to allow the user to feel the magnetic objects 102 when they are located at the first end 103. An example of a suitable obstruction is a sheet 105 as shown in FIG. 1 and described below.

In the example illustrated in FIG. 1, the device 100 comprises a first sheet 105a and a second sheet 105b. The first sheet 105a covers the first end 103a of the first solenoid 101a and the second sheet 105b covers the second end 103b of the second solenoid 101b. The sheets 105 are arranged to contain the respective magnetic object 102 within each solenoid 101 as the magnetic object 102 is moved to the first end 103 of the solenoid 101.

Each sheet 105 is such that the user, e.g. via finger 110, can feel the magnetic object 102 through the sheet 105 when the magnetic object 102 moves to the first end 103 of the solenoid 101. Each sheet 105 is sufficiently thin and/or deformable that it conforms, at least partially, to the shape of the magnetic object 102 when the magnetic object 102 is located at the first end 103 of the solenoid 101. For example, the sheets 105 may be made of an elastic material. Here “at least partially” means that the sheet 105 conforms enough allows the user to discern differences in shape of the magnetic objects 102 through the sheet 105.

examples, there may be separate sheets 105 for each solenoid or a single sheet may cover plural or even all the solenoids 10

Suitable materials for the basic sheet 05 include for example plastics.

In some examples, the sheets 105 may perform the additional function of activating the respective solenoid 101 (additional to the function of preventing the magnetic objects 102 from escaping), as described below in relation to FIG. 1.

In the example shown in FIG. 1, each sheet 105 is constructed and arranged to contact the first end 103 of the respective solenoid 101 when pressed by the user. Each sheet 105 is electrically connected to the second end 104 of the solenoid 101 via a DC power supply 106. The sheets 105 are electrically conductive on at least the side facing the solenoids 101. The electrically conductive side allows the user to complete a circuit through the respective solenoid 101 by pressing the sheet 105 with their finger 110. In an example, the sheets 105 are electrically insulating on the side that is touched by the user. The electrically insulating side prevents the user from receiving an electric shock when pressing the sheet 105 to complete the circuit. Nevertheless, the required voltage to operate the solenoids 101 may be low so it may not be necessary to have an electrically insulating side to the sheets 105 in some cases.

Each solenoid 101 may have its own DC power supply 106, as shown in FIG. 1, or the solenoids 101 may share a DC power supply. In any case, pressing down on a sheet 105 causes the sheet 105 to contact the solenoid 101 which completes a circuit through the respective solenoid 101, thereby allowing a current to be supplied through that solenoid 101. Each circuit comprises one of the solenoids 101 as electrically coupled to its power supply 106 (or single power supply in the case that the solenoids 101 share a power supply). As described above, this causes the magnetic object 102 of that solenoid 101 to accelerate towards the first end 103 where it can be felt by the user through the sheet 105.

In some examples, the user may press multiple sheets 105 and thereby complete multiple circuits through multiple solenoids 101. In examples comprising a single sheet 105, the user may still press the sheet 105 in multiple locations to complete multiple circuits through multiple solenoids 101.

The construction of the solenoids 101, magnetic objects 102 and sheets 105 is such that when a magnetic object 102 is located at the first end 103 of the solenoid 101, it can be felt by a user. With reference to FIG. 1, the user has used their finger 110 to press the first sheet 105a. This has caused a current to flow through the first solenoid 101a. The resulting magnetic field within the first solenoid 101a has caused the first magnetic object 102a to accelerate upwards to the first end 101a. The user will therefore feel, via their finger 110, the impact of the first object 102a on the first sheet 105a as the first object 102a strikes the first sheet 105a. The user may optionally continue to hold down the first sheet 105a in contact with the first solenoid 101a. This causes a continuing current to flow through the first solenoid 101a, holding the first magnetic object 102a at the first end 103a of the first solenoid 101a where the user can continually feel the first magnetic object 102a. This is advantageous as it allows the user more time to discern the shape (the haptic sensation) of the magnetic object 102a. The user may rub or swipe their finger 110 across the surface of the first sheet 105a to assist in feeling the shape of the magnetic object 102.

In other words, the user may use their finger 110 as shown in the figures to feel any magnetic object 102 which is located at the first end 103 of the solenoid 101. When a magnetic object 102 is not located at the first end 103 of the solenoid 101 (e.g. when located at the second end 104 of the solenoid), it cannot be felt by the user because it is out of reach.

The first magnetic object 102a and second magnetic object 102b have different shapes so as to provide different haptic feedback sensations to the user. That is, the first magnetic object 102a and second magnetic object 102b feel different when felt by e.g. a user's finger 110. In the example illustrated in the figures, the first magnetic object 102a is a sphere and the second magnetic object 102b is a stellated dodecahedron. The first magnetic object 102 (the sphere) creates a smoother haptic sensation on the user's finger 110 than the second magnetic object 102b (the stellated dodecahedron).

The magnetic objects 102 having different shapes means that the user is able to determine by touch alone which one or more of the solenoids 101 is activated, by which one (or more) of the magnetic objects 102 can be felt. This means that the user does not need to see the solenoids 101 in order to know which is/are active. The magnetic objects 102 may be provided in a variety of different shapes. For example, one magnetic object 102 may be “spiky” and/or “angular” and another magnetic object 102 may be “smooth” to provide discernibly different haptic sensations to a user's finger 110.

As mentioned above, the activation of each solenoid 101 may cause a different respective control command to be sent to an apparatus 300 (described below) for altering the operation of the apparatus 300. In this sense, therefore, the solenoids 101 act as control buttons for the apparatus 300. Hence, the user is able to ensure they activate the correct solenoid 101 for enacting a desired control command without requiring a view of the device 100. This is particularly advantageous for blind or partially-sighted users. To do so, the solenoids 101 of the device 100 are operatively coupled to a controller 200. The controller 200 is operatively coupled to the apparatus 300. The controller 200 is arranged to issue control commands to control the apparatus 300 in accordance with the solenoid or solenoids 101 through which a current is being supplied in use. The controller 200 may comprise a processor for performing the functionality described herein.

The controller 200 is able to determine a currently active one or more of the solenoids 101, i.e. the one or more of the solenoids 101 through which a current is passing, e.g. due to the user pressing the sheet 105 of those one or more solenoids 101 with their finger 110. In the example of FIG. 5, the controller 200 is connected to each of the circuits by a respective sense line allowing the controller 200 to determine when each solenoid 101 is active. For example, the controller 200 may be configured to measure a voltage on each sense line, a change (e.g. rise) in voltage indicating activation of the respective solenoid 101.

The controller 200 may be external from the apparatus 300, as shown in FIG. 5, or may be an internal controller 200 of the apparatus 300. Examples of apparatus 300 which may be controlled using the controller 200 include household and commercial appliances (also known as “white goods”), media devices, computing devices, etc. Examples of white goods include cookers (ranges, stoves, ovens, etc.), microwave ovens, refrigerators, freezers, water coolers, washing machines, clothes dryers, dishwashers, etc. Other examples of apparatus 300 include consumer electronic devices or “black goods”, e.g. a computers, televisions, etc.

The apparatus 300 functions in accordance with one or more settings.

In some examples, the settings may be a value which can be changed in order to alter operation of the apparatus 300. An example of such a setting is a temperature setting of an oven, a temperature setting of a wash cycle of a washing machine, etc.

In other examples, one of the settings may be a program consisting of a set of steps to be performed by the apparatus 300. The user is able to select a desired program to be executed by the apparatus 300. Examples of such a setting include a wash cycle of a washing machine, a defrost cycle of a freezer, etc.

The one or more settings may comprise both values and programs.

The controller 200 may be configured to issue control commands to control the apparatus 300 in accordance with the solenoid or solenoids 101 through which a current is being supplied in use. That is, each solenoid 101 is associated with a control command for altering the operation of the apparatus 300. The user can then cause a desired change to the operation of the apparatus 300 by activating the relevant one or more of the solenoids 101 by pressing the sheet 105 of those one or more solenoids 101.

As a specific example, the first solenoid 101a may be associated with a decrease temperature control command and the second solenoid 101b may be associated with an increase temperature control command. In this way, the user does not require a view of the solenoids 101 in order to increase or decrease the temperature setting of the apparatus 300, because the user is able to feel which solenoid 101 has been activated using their finger 110.

The shape, and therefore feel, of each magnetic object 102 may be associated with the respective control command. For example, the magnetic object 102 located in the solenoid 101 that causes an increase to a temperature setting may be sharper than the magnetic object 102 located in the solenoid 101 that causes a decrease to the temperature setting. That is, a “decrease temperature control command” may for example be indicated by a smooth shape object 102a and an “increase temperature control command” may for example be indicated by a spiky or angular shape object 102b.

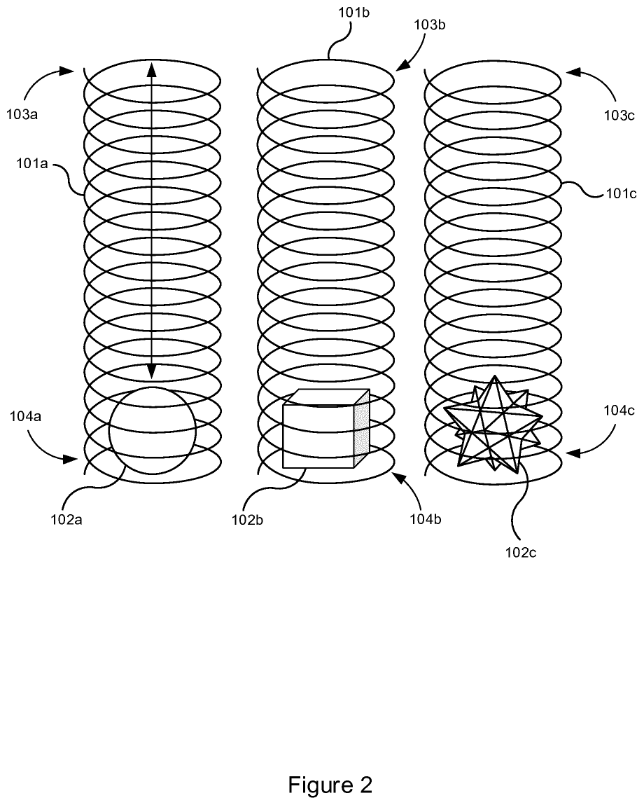

FIG. 2 shows schematically an example comprising three solenoids 101a, 101b, 101c. Each solenoid 101 has a first end 103 and a second end 104 and contains a movable magnetic object 102. The operation of each solenoid arrangement is as described above and so not repeated here.

The first magnetic object 102a, second magnetic object 102b and third magnetic object 102c all have different shapes. In this example, the first magnetic object 102a is a sphere (an example of a “smooth” shape), the second magnetic object 102b is a cube (an example of an “angular” shape), and the third magnetic object 102c is a stellated dodecahedron (an example of a “spiky” shape). Each shape feels different to the user and thereby creates a different haptic sensation on the user's finger 110.

Each of the solenoids 101a, 101b, 101c may be associated with a different respective control command, as described above. For example, each solenoid 101 may be associated with a control command to enact a different respective program. In a specific example, the apparatus 300 may be a washing machine and each solenoid 101 is associated with a different respective wash cycle. The user can then select the desired wash cycle using touch alone.

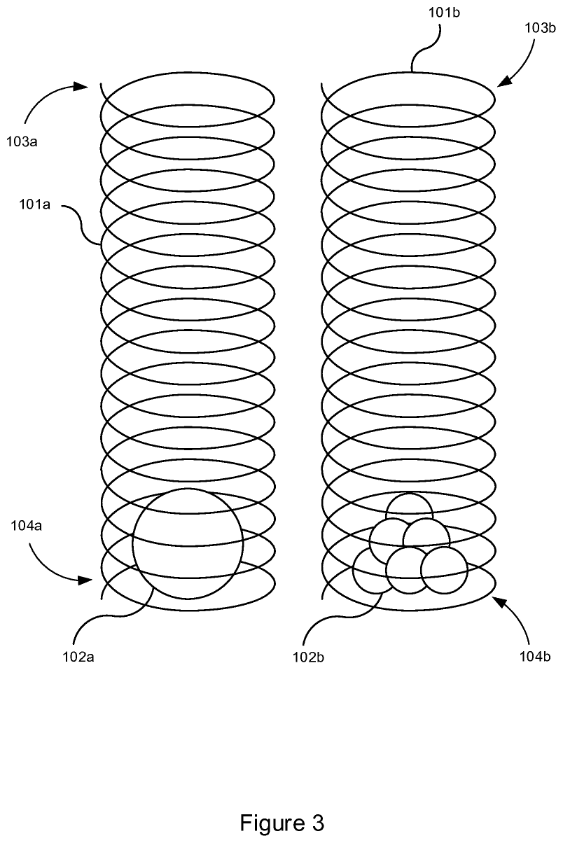

FIG. 3 shows schematically an example in which different numbers of magnetic objects 102 are provided in each solenoid 101. In this example, the first solenoid 101a contains a single magnetic object 102a which is a sphere and the second solenoid 101b contains six magnetic objects 102b which are all spheres. The spheres of the second solenoid 101b are each the same size and smaller than the sphere of the first solenoid 101a.

Even though the magnetic objects 102 in both solenoids 101 are all the same shape, they provide different haptic sensations to the user because the single sphere in the first solenoid 101a will feel different on the user's finger 110 than the multiple smaller spheres in the second solenoid 101b. A similar principle holds for shapes other than spheres. Six spheres in the second solenoid 101b are shown as an example only. Different numbers of magnetic objects 102 may be provided. For example, two magnetic objects will feel different from a single magnetic object, and different still from for example ten magnetic objects, even if they are all the same shape.

In the examples described above, the solenoids 101 are vertical such that the magnetic objects 102 rest at the bottom (second end 104) of the solenoids 101 due to gravity when no current is passing through the solenoid 101, i.e. a current needs to be supplied to the solenoids 101 to move the magnetic objects 102 to the top (first end 103). However, the direction of the force generated depends on the direction of the current through the solenoid 101. Therefore, in other examples, the device 100 is constructed and arranged to actively hold the magnetic objects 102 at the second ends 104 of the solenoids 101 by applying the reverse current. This means that the solenoids 101 do not need to be installed in the vertical position.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A device for providing haptic feedback to a user, the device comprising:
a first magnetic object;
a first solenoid constructed and arranged to move the first magnetic object to a first end of the first solenoid where the first magnetic object can be felt by the user when a current is supplied through the first solenoid;
a second magnetic object; and
a second solenoid constructed and arranged to move the second magnetic object to a first end of the second solenoid where the second magnetic object can be felt by the user when a current is supplied through the second solenoid;
wherein the first and second magnetic objects have different shapes so as to provide different haptic feedback sensations to the user.

2. A device according to claim 1, wherein at least one of the solenoids comprises a sheet which covers the first end of the solenoid to contain the respective magnetic object within the solenoid as the object is moved to the first end of the solenoid.

3. A device according to claim 2, wherein each of the solenoids comprises a sheet which covers the first end of the solenoid to contain the respective magnetic object within the solenoid.

4. A device according to claim 2, wherein the or each sheet is electrically conductive and is constructed and arranged to contact one or more of the solenoids when pressed by the user to complete a circuit through the one or more of the solenoids, thereby allowing a current to be supplied through said one or more of the solenoids.

5. A device according to claim 1, comprising:
a third magnetic object; and
a third solenoid constructed and arranged to move the third magnetic object to a first end of the third solenoid where the third magnetic object can be felt by the user when a current is supplied through the third solenoid;
wherein the third magnetic object has a different shape from each of the first and second magnetic objects and thereby provides a different haptic feedback sensation to the user.

6. A device according to claim 1, wherein the shape of at least one of the magnetic objects is spherical.

7. A device according to claim 1, wherein the shape of at least one of the magnetic objects is a convex polyhedron.

8. A device according to claim 1, wherein the shape of at least one of the magnetic objects is a concave polyhedron.

9. A device according to claim 1, wherein one or more of the solenoids is constructed and arranged to move a plurality of magnetic objects of the same shape to the first end of the solenoid.

10. An apparatus comprising a controller for controlling the apparatus, and a device according to claim 1, the solenoids of the device being in communication with the controller, the controller being arranged to issue control commands to control the apparatus in accordance with the solenoid or solenoids through which a current is being supplied in use.

11. A method of providing haptic feedback to a user, the method comprising:
selectively supplying a current to one or more of a first solenoid and a second solenoid;
wherein supplying the current to the first solenoid causes the first solenoid to move a first magnetic object to a first end of the first solenoid where the first magnetic object can be felt by the user, the first object having a first shape for providing a first haptic feedback sensation to the user;
wherein supplying the current to the second solenoid causes the second solenoid to move a second magnetic object to a first end of the second solenoid where the second magnetic object can be felt by the user, the second object having a second shape different from the first shape for providing a second haptic feedback sensation to the user different from the first haptic sensation.

12. A method according to claim 11, comprising selectively supplying a current to one or more of the solenoids by selectively pressing an electrically conductive sheet to contact the one or more of the solenoids to complete a circuit through the one or more of the solenoids, thereby allowing a current to be supplied through the one or more of the solenoids.

13. A method according to claim 11, wherein the shape of at least one of the magnetic objects is spherical.

14. A method according to claim 11, wherein the shape of at least one of the magnetic objects is a convex polyhedron.

15. A method according to claim 11, wherein the shape of at least one of the magnetic objects is a concave polyhedron.
